(19) United States
(12) Patent Application Publication
(10) Pub. No.: US 2019/0052655 A1
(43) Pub. Date: Feb. 14, 2019

(54) METHOD AND SYSTEM FOR DETECTING MALICIOUS AND SOLICITING ELECTRONIC MESSAGES

(71) Applicant: IronScales LTD, Givatayim (IL)

(72) Inventor: Eyal BENISHTI, Givatayim (IL)

(21) Appl. No.: 16/077,494

(22) PCT Filed: May 10, 2017
(86) PCT No.: PCT/IL2017/050513

§ 371 Date: Aug. 13, 2018

Related U.S. Application Data
(60) Provisional application No. 62/333,869, filed on May 10, 2016.

(51) Int. Cl. H04L 29/06; H04L 12/58

(52) U.S. Cl. CPC H04L 63/1416; H04L 51/12; H04L 51/34; H04L 63/1483

(57) ABSTRACT

The subject matter discloses system and method for identifying malicious and soliciting network messages. According to some embodiments the system monitors the client or the server of the messaging system and/or the service of the messaging system for detecting alerting operations by user of the service. If such operations are detected the system identifies the message that is associated with the operation as a suspicious message. The system then performs enhanced operations in order to determine if the suspicious message is a malicious or soliciting message.

### FIELD OF THE INVENTION

The present disclosure relates to internet security in general, and to malicious and soliciting electronic messages in particular.

### BACKGROUND OF THE INVENTION

Phishing is the attempt to obtain sensitive information such as usernames, passwords and credit card details, often for malicious reasons, by disguising as a trustworthy entity in an electronic communication

Phishing is typically carried out by email spoofing or instant messaging and it often directs users to enter personal information at a fake website, the look and feel of which are almost identical to the legitimate one communications purporting to be from social web sites, auction sites, banks, online payment processors or it administrators are often used to lure victims. Phishing emails may contain links to websites that are infected with malware.

Phishing may also be used for attacking organization. In some cases the phishing message has a network address or a domain that is similar to a network address or domain that is known to the user or to the organization.

### SUMMARY OF THE INVENTION

The term computing device refers herein to one or more of a client computer, a server computer a desktop computer, a mobile computing device such as a smart-phone, tablet computer or laptop computer, and a dumb terminal interfaced to a cloud computing system.

The term electronic message refers herein to a message that is transferred between computing devices that are connected via the internet or intranet network. Examples of such network messages are email message, SMS message, MMS messages, WhatsApp messages and etc.

The term similar electronic message refers herein to a message whose parameters and/or header are similar to another electronic message.

The term suspicious message refers herein to a network message that is detected by the system as suspicious for being a malicious message or a soliciting message.

The term alerting operation refers herein to an operation of the user with regard to an electronic message that indicates that an electronic message is a suspicious message. Examples of such alerting operations are deleting an electronic message, forwarding an electronic message, marking (flagging or tagging) an electronic message with a special mark (flag or tag) and moving an electronic message to a folder.

The term unknown sender refers herein to a sender of an electronic message whose at least one of it's sender's parameters is first received by a user of an electronic messaging system. Examples of such sender's parameters are IP (internet protocol) address of the sender, authorization header (Like SPF, DKIM or DMARC), name of the sender and network address of the sender.

The term trusted sender refers herein to a sender of a message from which the recipient initiated communication session, or received more than predefined number of electronic messages, or reply to electronic messages received from this sender or send more than predefined number of messages to this sender and/or never reported the sender as suspicious. In some embodiments if the sender is an unknown sender to the recipient, the sender may be identified as trusted if it is identified by messaging system of one or more other users as trusted. The one or more other users may belong to same organization or to other organizations.

The Term non-trusted sender refers herein to a sender of an electronic message that is not a trusted sender.

Embodiments of the invention disclose system and method for identifying malicious and soliciting network messages.

According to some embodiments the system monitors the client or the server of the messaging system and/or the service of the messaging system for detecting alerting operations by a user of the service. If such operations are detected the system identifies the message that is associated with the operation as a suspicious message.

According to some embodiments the system further monitors the client or the server of the messaging system and/or the service of the messaging system for detecting electronic messages that are sent from a non-trusted sender. If such non-trusted sender is detected the system identifies the message that is sent from this sender as a suspicious message.

The system then performs enhanced operations in order to determine if the suspicious message is a malicious or soliciting message.

According to some embodiments the system selects a mitigation action when detecting a malicious or soliciting network message. Examples of such mitigation actions are blocking the electronic message from being displayed to the user, inserting the electronic message to a junk list, deleting the electronic message, disabling links/attachments, quarantining or moving the electronic message to a different location, queuing/delaying the electronic message until investigated by higher skill rank, adding message/alert/hints/guidance inside the electronic message text or within the email client messaging areas, marking the electronic message or its preview with flags or custom icons, colors or any other visual sign, sending attachment/links for deeper/longer/manual scanning and analysis; and/or replacing links name with target address; highlighting links target domains; adding inline message with useful information about the electronic message to aid decision (for example sender address/domain); or executing any other operation that might block and/or highlight such malicious or solicited electronic message.

According to some embodiments the system may also perform the mitigation actions.

According to some embodiments the enhanced operations that are performed in order to decide if the message is malicious or soliciting include any combination of: analyzing parameters associated with a behavior of a user with the messaging service (user behavior analysis), analyzing parameters associated with the electronic message or similar electronic messages in the past, analyzing parameters associated with the behavior of other users with same or similar message and analyzing parameters associated with user awareness.

According to some embodiments system assigns a specific suspicious level and weight to each analysis and combining the suspicious level in accordance with the assigned weights.

According to some embodiments if the message is detected as non-trusted, the level of suspiciousness may be further enhanced when detecting that the user performs an alerting operation on the message.

According to some embodiments the events of identifying a suspicious message and of identifying a malicious or soliciting message are stored in a data repository and are utilized for performing an analysis on user behavior with regard to same or similar messages. According to some embodiments the data associated with the events is also stored in the data repository and is used for performing an analysis on user behavior with regard to same or similar messages.

According to some embodiments all the operations of a user with regard to his messaging system are stored an analyzed. According to some embodiments the analysis may be performed by machine learning techniques. The analysis may classify the event operation of the user on electronic messages as normal or abnormal.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a system for detecting malicious and soliciting electronic messages, in accordance with some exemplary embodiments of the disclosed subject matter;

FIGS. 2A, 2B and 2C show a flowchart diagram of a method for detecting malicious and soliciting electronic messages in accordance with some exemplary embodiments of the disclosed subject matter;

FIG. 3 shows a flowchart diagram of user behavior analysis, in accordance with some exemplary embodiments of the disclosed subject matter;

FIG. 4 shows a flowchart diagram of a method for alerting about malicious and soliciting electronic messages, in accordance with some exemplary embodiments of the disclosed subject matter;

FIG. 5 shows a presentation of a message that is received from an non-trusted sender, in accordance with some exemplary embodiments of the disclosed subject matter;

FIG. 6 shows a plurality of bars, in accordance with some exemplary embodiments of the disclosed subject matter; and

FIG. 7 shows a message read window displaying the bar, in accordance with some exemplary embodiments of the disclosed subject matter.

### DETAILED DESCRIPTION

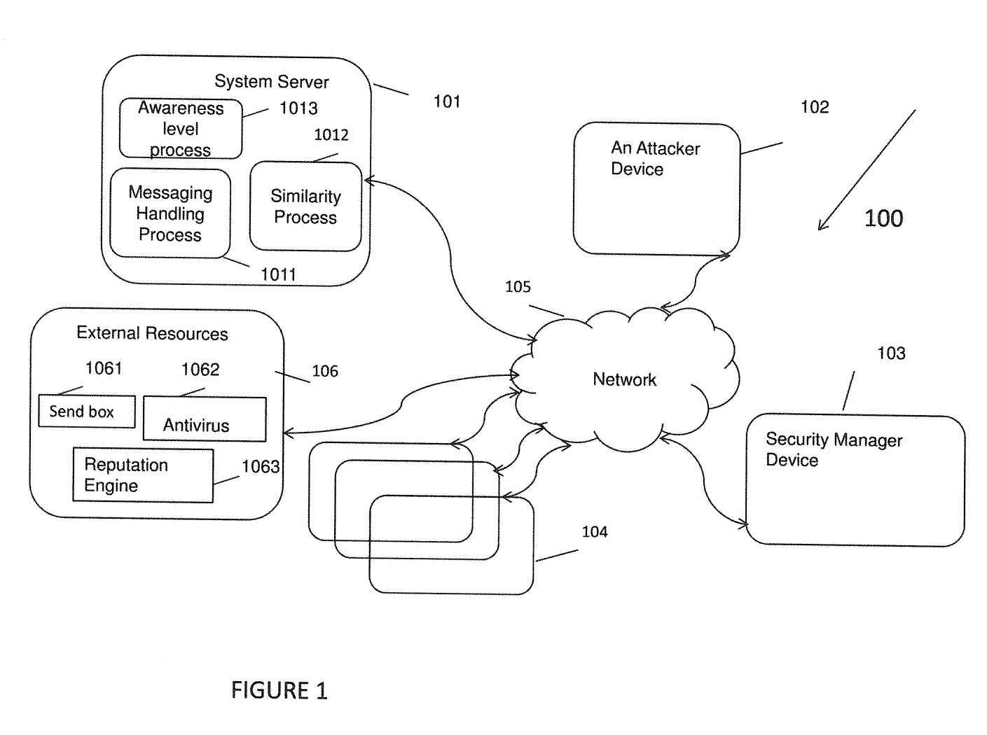

FIG. 1 shows a block diagram of a system for detecting malicious and soliciting electronic messages, in accordance with some exemplary embodiments of the disclosed subject matter. System 100 includes a system server 101, an attacker device 102, a security manager 103, external resources 106 and a plurality of computing devices 104.

The system server 101 is configured for detecting the alerting operations in the plurality of users of the computing devices 104, for identifying suspicious messages and malicious or soliciting messages and for performing mitigation.

According to some embodiments the system server 101 may include a messaging handling process module 1011, a similarity process 1012 and an awareness level process 1013.

The messaging handling process 1011 is configured for monitoring a plurality of clients of the messaging service. The messaging handling process 1011 is also configured for monitoring the server of the messaging service. The plurality of clients may be installed in the plurality of computing devices 104 of users of the messaging service. The monitoring may be performed via the network 105.

According to some embodiments the monitoring is for analyzing a behavior of the user with the messaging service. The monitoring is also for detecting alerting operations.

The messaging handling process 1011 is further configured for identifying electronic messages that are involved in the alerting operations as suspicious messages and for performing enhanced operations on the suspicious message. The enhanced operations are for determining if the electronic message is a malicious or soliciting message. The malicious message may be sent from one or more attacker device 102.

The messaging handling process 1011 is further configured for determining the mitigating actions and for performing the mitigation actions.

The messaging handling process 1011 communicates with the external resources 106 for scanning relevant properties such as links, attachments, domains IPs. The external resources may be antivirus 1062 for scanning for viruses in the message, sand box 1061 for operating tests on the message and reputation engine 1063 for determining the reputation of the sender of the electronic message.

The message handling process 1011 may be connecting to the emails service through its API or by a listening process on the client side or as a device installed in the middle as a traffic listener both inline or not inline to the traffic.

The similarity process 1012 is configured for identifying similar messages. Messages may be identifies as similar according to for example, same sending name or address, same origin SMTP server or same SMTP servers path, same links name and addresses or same attachments filename or signature (Hash or Fuzzy Hash) or any other feature similarity that might indicate that the electronic messages are basically the same message with some changes.

The similarity process 1012 is used by the message handling process 1011 for aggregating statistics related to behavior of a plurality of user on same or similar messages.

The awareness level process 1013 is configured for identifying the awareness of a user to suspicious electronic messages. An operation of a user with high level of awareness may have a high probability of detecting a malicious or soliciting message.

The awareness level for each user of the plurality of user devices 104 can be set automatically according to his success/failure rate to report targeted email attacks in the past when they happened, manually by a system administrator or other authorized person, or a combination thereof. The system administrator may apply a simulated attack program to determine the user awareness level. The awareness level may change over the time based on the user performance in a simulated attack program and the day to day experience, or manually by a system administrator or other authorized person.

The security manager device 103 receives messages that are forwarded from user of the messaging services as a result of identifying the message as suspicious by the user.

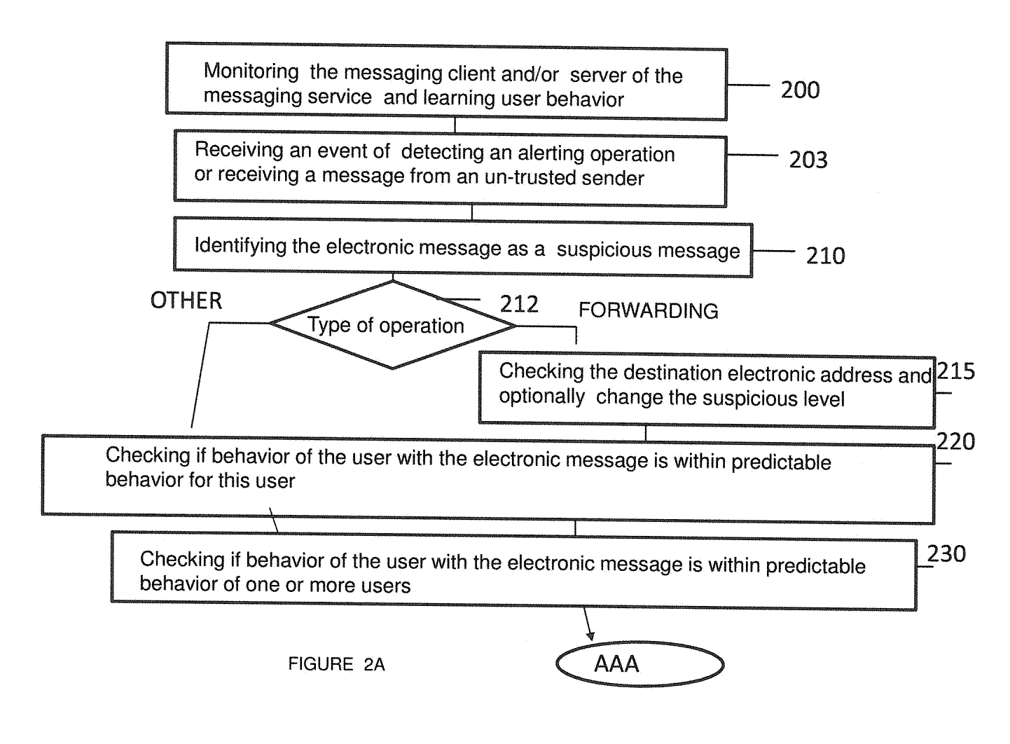

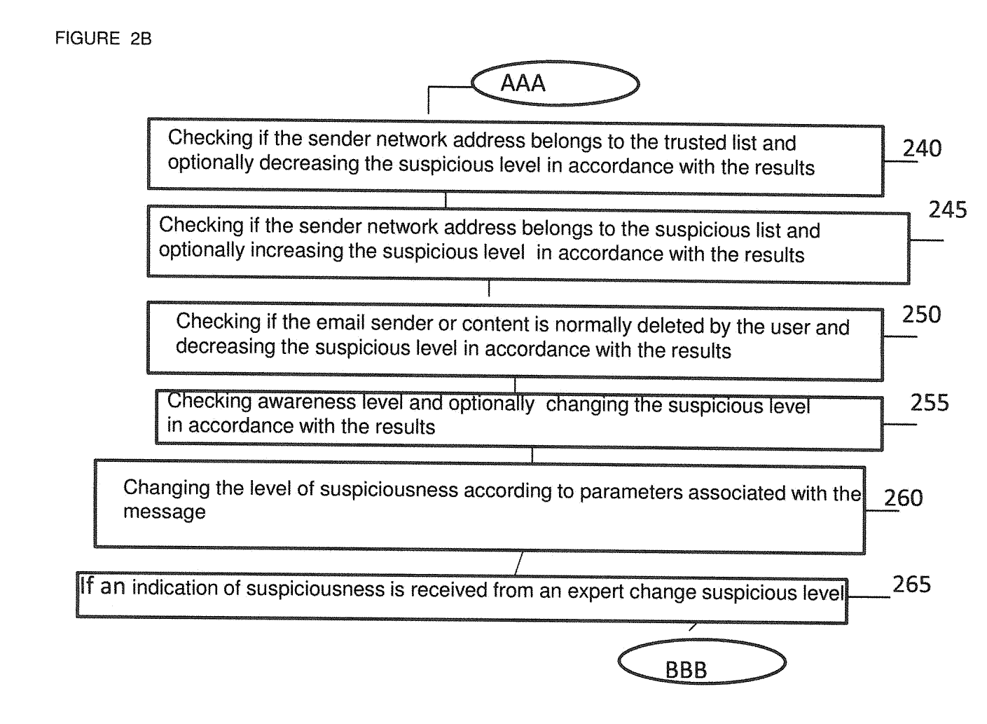

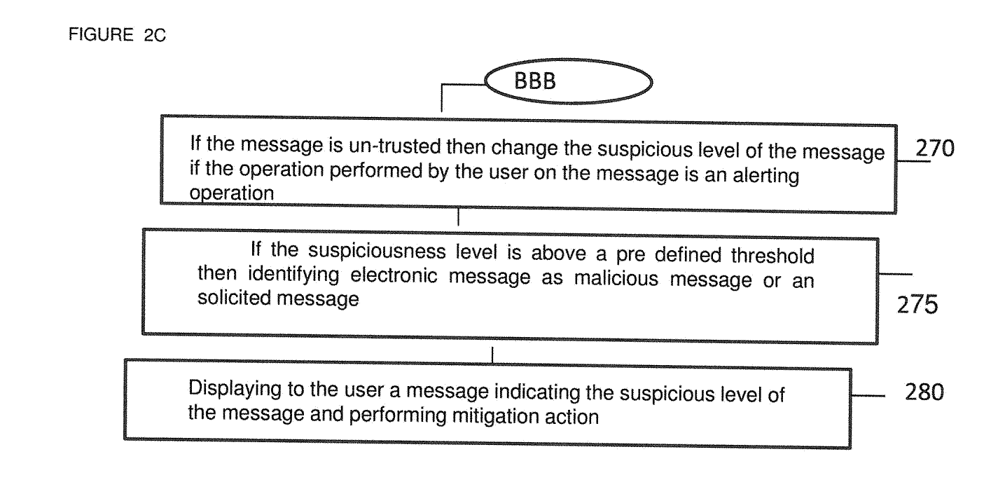

FIGS. 2A, 2B and 2C show a block diagram of a method for detecting malicious and soliciting electronic messages in accordance with some exemplary embodiments of the disclosed subject matter.

According to some embodiments the system learns the behavior of a user and/or the behavior of a plurality of users with the electronic messages. The learning may be done by monitoring the messaging client and/or server of the messaging service and by performing machine learning. The monitoring includes monitoring the time from reading the message to performing other operation with the message, monitoring date and time associated with the receiving of an electronic message and with the performing operation on the electronic message, monitoring mouse movements, keystrokes, hovering, clicking associated with receiving an electronic message or with performing an operation with the electronic message etc.

The learning may be, for example for classifying abnormalities user behavior or for classifying normal behavior. Such classifying may be with regard to a certain user or with regard to a plurality of users. Such classifying may be used for enhancing the suspicious level of an electronic message.

According to some embodiments the system monitors the client of the messaging system and/or the messaging service for detecting alerting operations by the user of the service. If such operations are detected the system identifies the electronic message that is associated with the operation as a suspicious message.

According to some embodiments the system further monitors the client or the server of the messaging system and/or the service of the messaging system for detecting electronic messages that are sent from a non-trusted sender. If such non-trusted sender is detected the system may identify the message that is sent from the non-trusted sender as a suspicious message.

The monitoring is done by listening or registering to events on client or server side, to events such as new message arrived or email has been navigated to/being read, or by scanning for changes using brute force repeating scan.

The system then performs enhanced operations in order to determine if the electronic message is malicious or soliciting.

According to some embodiments the enhanced operations that are performed in order to decide if the message is malicious or soliciting include any combination of the following: searching sender identification in a suspicious list that is generated by the learning process, comparing a behavior of a user with the electronic message to user predictable behavior, comparing a behavior of users with same or similar message to predictable behavior of the one or more uses, analyzing user awareness to suspicious message, analyzing parameters associated with the message and an indication received from a security expert.

It should be noted that the system may assign a specific weight for each alert operation and that the weigh may be changed throughout the time. The level of suspiciousness may be calculated by the score of the sum of the respective suspicious levels of individual alert operations.

Referring now to the drawings:

At block 200 the system monitors the messaging client and/or server of the messaging service for detecting alerting operations. The system may also learn the behavior of the user with the messaging system via the monitoring.

At block 203 the system receives an event of detecting an alerting operation. The alerting operation is performed by the user of the messaging service whose operations are monitored. In another scenario the system receives an electronic message from a non-trusted sender. Examples of alerting operations are deleting an electronic message, forwarding an electronic message, flagging an electronic message and moving the electronic message to a folder

At block 210 the system identifies the electronic message as suspicious.

The system assigns suspicious level for the electronic message

At blocks 212, 215, 220, 230, 240, 245, 250, 255 260, 265 and 270 the system performs enhanced operations in order to decide if the message is malicious or soliciting.

At block 212 the system checks the type of operation. If the type of operation is forwarding then the operation continues to block 215 otherwise the operation continues to block 220.

At block 215 the system checks the destination network address. If the destination network address is equal to a certain network address then the suspicious level of the electronic message may be increased. For example the suspicious level is increased by 5%. The certain network address may be for example a network address of a security administrator or a network address of the IT department.

At block 220 the system checks if behavior of the user with the electronic message is within predictable behavior for this user. The predictable behavior is determined by the learning operation. For example: the system checks the time that has elapsed from the reading to the forwarding. If the elapsed time is within the predictable time then the suspicious level of the electronic message may be increased. For example if the elapsed time is less the 5 seconds the suspicious level of the electronic message is increased by 15%.

At block 230 the system determines if behavior of one or more users with same or similar electronic message is within a predictable behavior of the one or more users. The one or more users may or may not include this user.

The one or more users may belong to same or other organization. In some embodiments the other users are a subset group of the group of users that utilize the messaging service. The predictable behavior may be defined by a process that learns the behavior of the one or more users.

The system may increase or decreases the suspicious level of the electronic message according statistic data that was calculated from the behavior of a plurality of other users of the messaging service. Such statistic data may include the percentage of deleting the message within a certain period time and the percentage of forwarding the message to a certain predefined email address within a certain period of time.

At block 240 the system checks if the sender network address belongs to the trusted list that is generated in the user behavior analysis. If the sender network address belongs to the trusted list then the suspicious level of the electronic message may be decreased by a certain percentage.

At block 245 the system checks if the sender network address belongs to the suspicious list that is generated in the user behavior analysis. If the sender network address belongs to the suspicious list then the suspicious level of the electronic message may be increased by a certain percentage.

At block 250 the system checks if the email sender or content is normally deleted by the user; if so the suspicious level of the electronic message may be decreased.

At block 255 the system may change the level of suspiciousness according to user awareness. If the user awareness level is high the suspicious level may be increased. If the awareness level is low then the suspicious level may be decreased.

At block 260 the system analyses parameters associated with the electronic message. The system extracts email metadata such as headers. The metadata may include Received header, return-path, Sender name, From, Subject of the message, X-headers, domain name, reply etc.

The system then checks for suspicious indications like: sender name different from return-path, reply address different from sender address, new sending domain (registered lately), or any other indication. The suspicious indications may also be attachments, links and scans results. The suspicious indications may also be a new domain. The term new domain refers herein to a domain of an electronic message that has registered lately, that is to say, in a date that is not older then a predefined date. The system may interface with external resources antivirus for scanning for viruses in the message, sand box for operating testing on the message and reputation engine for determining the reputation of the sender of the electronic message.

The system may increase or decrease the suspicious level of the electronic message as a result of the checks.

At block 265 the system check if a message indication for suspiciousness has been received from a security expert. If such indication has been received the suspicious level of the message may increase.

If the message is non-trusted then at block 270 the system may further change the suspicious level of the message if the operation performed by the user on the message is an alerting operation.

At block 275 the system may identify the electronic message as a malicious message or an soliciting message according to the suspiciousness level; that is to say, if the suspiciousness level is above a pre defined threshold then the electronic message is identifies as malicious message or an soliciting message. If the message is identified as malicious or unselecting the system may perform preventive actions.

At block 280 the system display to the user a message indicating the suspicious level of the message. The system may also perform other mitigation actions.

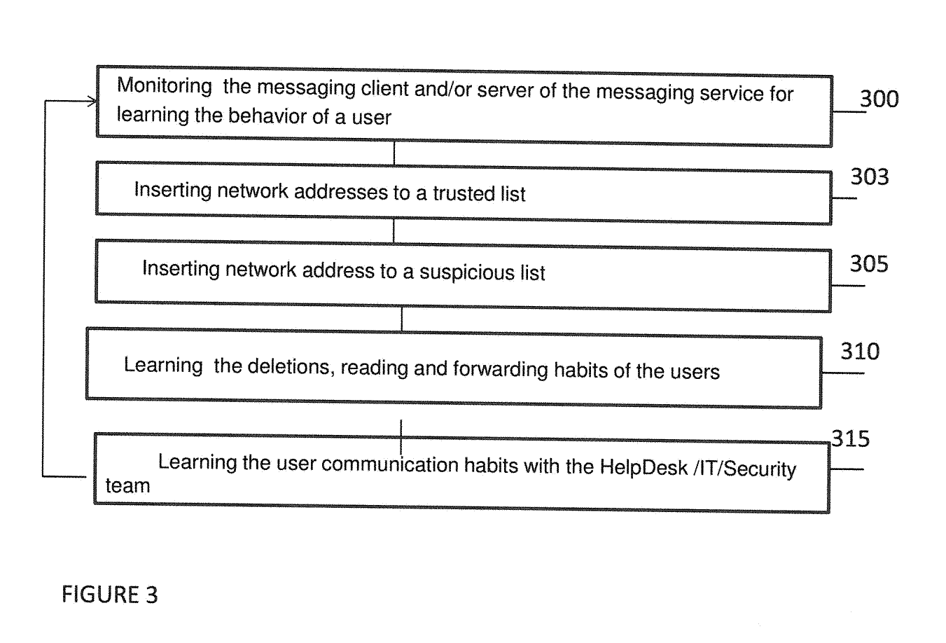

FIG. 3 shows a block diagram of user behavior analysis, in accordance with some exemplary embodiments of the disclosed subject matter.

According to some embodiments the system performs the behavior analysis on the operation of the user with the electronic messaging service. The behavior analysis is for providing data that assist in determining a suspicious message as a malicious message or as soliciting message. The operations of the users that are monitored are reading messages, read to delete time, forward, forward to delete time.

The behavior analysis includes learning the deletion habits, the forwarding habits of the user, the replying habits of the user, adding contacts to the contact list. The behavior analysis may also include learning changes in the contact list the junk folders and rules that the user has applied on the messaging service.

According to some embodiments the behavior analysis is performed by implementing deep neural network. The deep neural network is used for identifying anomalies for learning the user behavior and for classifying expected reactions to the incoming messages.

According to some embodiment a network is trained with a supervised feedback, on part or the entire raw data. Such raw data may be for example IP address, subject content, time, etc. of the entire set of users. The messages which are fed into the learning algorithm are being labeled according to the user reaction to the messages and according to the anomalies which were discovered by experts and may be used as ground truth.

In a second stage the trained network is trained with a supervised feedback on part/entire raw data of each specific user. Such training enables the system to learn global patterns that are common to all users and also to develop expertise based on local patterns such as individual user and unique patterns.

Another fine tuning can occur while getting feedback from experts, or the user itself, during the on-line phase, in which the system is operating to classify the messages.

In addition to the deep neural network, another auxiliary machine learning components can be trained to improve the message analysis. For example, an auxiliary deep neural network can be trained to perform natural language processing to derive numerical representations for the content of the email. The numerical representations can be fed into the master network classifier with more raw inputs such as IP address which require less pre-processing.

Referring now to the drawings:

At block 300 the system monitors the messaging client and/or server of the messaging service for learning the behavior of a user. Learning may be performed by machine learning methods.

At block 303 the system inserts network addresses to a trusted list. The trusted list includes network addresses of users of the messaging service that are classified by the user behavior analysis process as not being suspected.

The trusted list may include network addresses from the contact list, network addresses with which the user communicates frequently and network address whose messages are frequently deleted by the user.

The trusted list may also be generated from rules that the user applies on the messaging service. For example, if the messaging service is a mailing service then the system may include a network address of a sender in a trusted list if this sender is included in a rule that automatically forwards all the mails from this sender to a certain folder in the email.

At block 305 the system inserts network address to a suspicious list. The suspicious list includes network address of users of the messaging service that are suspected by the user behavior analysis process as malicious or soliciting. In one embodiment network addresses of senders that are in the junk mail are included in the suspicious list. In another examples network addresses of senders whose messages are forwarded to deleted item folder or to junk folder are also included in the suspicious list.

At block 310 the system learns the deletions, reading and forwarding habits of the users both by contact content and other metadata. The learning is for classifying normal and abnormal behavior. The habits may refer to timing of performing operation, senders associated with the operation, domains associated with the operation etc. The system may also learn any other behavior of the user with regard to the operation with the electronic messages including timing of performing the operation, delays, frequency mouse keyboard hovering and touch activities, etc.

At block 315 the system learns the user communication habits with the Helpdesk/IT/Security team. Operation resumes to block 300.

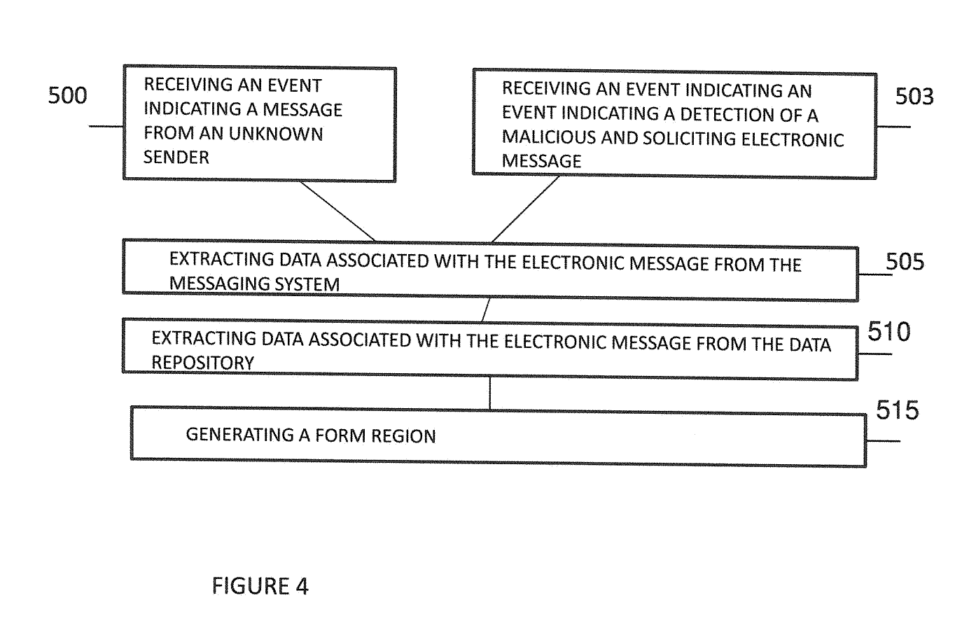

FIG. 4 shows a flowchart diagram of a method for alerting about malicious and soliciting electronic messages, in accordance with some exemplary embodiments of the disclosed subject matter

According to some embodiments the user is alerted about receiving a malicious and soliciting electronic message. In some embodiments upon detecting such malicious and soliciting electronic message the system extracts data associated with the electronic message. The data may be extracted from the messaging system or from a data repository includes statistic information that has been collected while learning the user behavior of the messaging system. The system displays an alerting message to the user. The alerting message may include parameters such as sender's name, network address and domain, network address of similar domains, reputation of the sender, number of electronic messages received from this sender, number of electronic messages sent to this sender and etc.

Referring now to the drawing:

At block 500 the system receives an event indicating the receiving of a message from an unknown user. Operation proceeds to block 505.

At block 503 the system receives an event indicating a detection of a malicious and soliciting electronic message.

At block 505 the system extract data associated with the electronic message from the messaging system. Such data may include the network address of the sender, name of the sender, a network address of the domain that is similar to the network address of the sender's domain, date and time of receiving the electronic message etc.

At block 510 the system extracts parameters associated with the electronic message from a data repository that stores data that was calculated by the analysis of the behavior of users with said messaging system. Such parameters may include reputation of the sender, number of electronic messages received from this sender, number of electronic messages sent to this sender etc.

At block 515 the system generates a form region. The form is for generating the bar into which the alerting is inserted. The bar may be presented in the reading pan of the messaging system. In one example the bar is presented on the reading pan of the outlook. The reading pan may be customized by using built in VSTO library or by using inbox-SDK in the GMAIL messaging system.

The bar may be also inserted in the message read window. The bar may include an expand button to allow expanded data.

The bar may also include an OK bottom which enables to insert the sender into a white list.

The bar may include all the parameters that are extracted from the data base and from the messaging system.

The bar may include an alerting message. The alerting message may indicate the receiving of a mail from an unknown sender or the detecting of a malicious and soliciting electronic message.

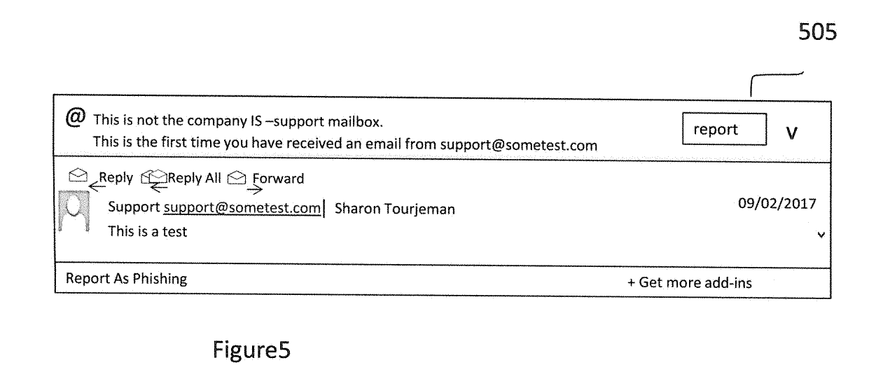

FIG. 5 shows a presentation of a message that is received from an unknown sender, in accordance with some exemplary embodiments of the disclosed subject matter. The bar is presented in the reading pan 505. The bar includes the alerting message: “This is the first time you received an email from Support”.

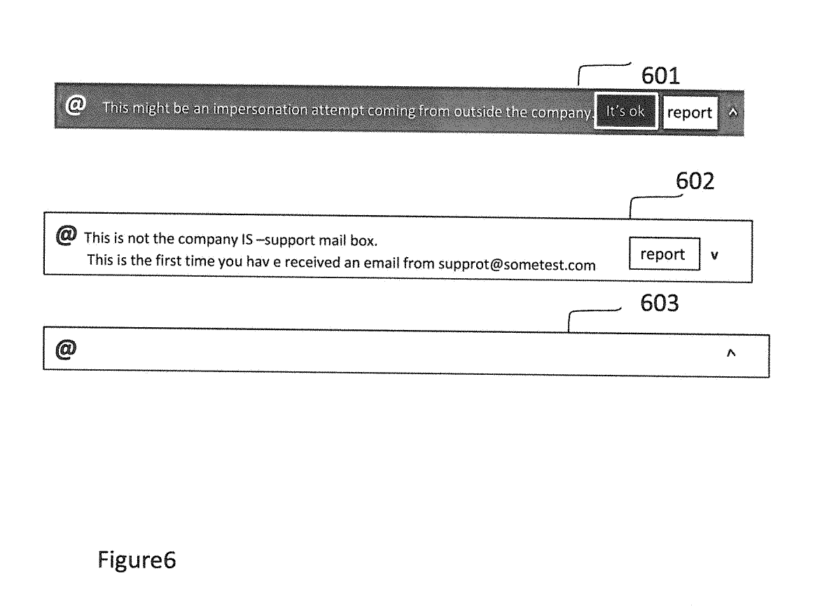

FIG. 6 shows a plurality of bars, in accordance with some exemplary embodiments of the disclosed subject matter.

Bar 601 displays an alerting message about receiving a message from outside the company.

Bar 602 displays an alerting message about receiving a message from unknown sender.

Bar 603 has no alerting message and is typically displayed when the received message is not malicious.

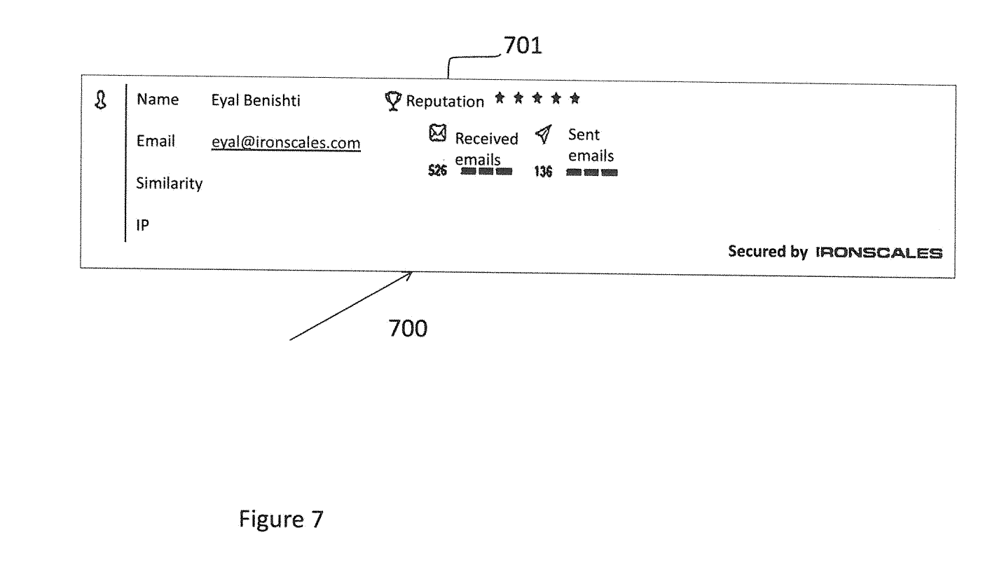

FIG. 7 shows a message read window displaying the bar, in accordance with some exemplary embodiments of the disclosed subject matter. Message 700 includes the bar 701

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that, in some alternative implementations, the functions noted in the block of a figure may occur out of the order noted in the figures. For example, two blocks shown in succession may, in fact, be executed substantially concurrently, or the blocks may sometimes be executed in the reverse order, depending upon the functionality involved.

1. A method for detecting malicious or soliciting electronic messages in a messaging system:
the method comprising:
receiving a first event indicating performing an alerting operation by a user; wherein said alerting operation comprises an at least one member of a group consisting of deleting said electronic message, forwarding said electronic message, flagging said electronic message and moving said electronic message to a folder; or
receiving a second event indicating the receiving of an electronic message from an non-trusted sender;
in response to said first event or said second event determining said electronic message as suspicious and determining level of suspiciousness;
enhancing said level of suspiciousness according to at least of one member of a group consisting of: determining if behavior of said user with said electronic message is within first predictable behavior; wherein said first predictable behavior derived from learning behavior of said user with said electronic message; determining if behavior of said user with said electronic message is within second predictable behavior; wherein said second predictable behavior derived from learning behavior of one or more users with same or similar electronic message; analyzing parameters associated with said electronic message, searching sender identification in a suspicious list or in trusted list wherein said suspicious list or said trusted list is generated by said learning said behavior of said user or said one or more users and analyzing awareness of said user to suspicious messages, thereby providing an enhanced level of suspiciousness; and
identifying said suspicious message as a malicious or soliciting message in according with said enhanced level of suspiciousness.

2. The method of claim 1 further comprising if said first event indicating said forwarding said electronic message then extracting destination network address from said forwarding message and if said destination network address of said forwarding message being a network address of a security administrator or a network address of an IT department then performing said enhancing said level of suspiciousness.

3. The method of claim 1, wherein said analyzing parameters associated with said electronic message comprises extracting metadata and analyzing said metadata for suspicious indications.

4. The method of claim 3 wherein said analyzing said metadata comprises one member of a group consisting of: identifying difference between sender name and return-path, identifying difference between sender name and reply to other address, and identifying new sending domain.

5. The method of claim 1, further comprising displaying an alerting message on a reading pan of said messaging system in response to said identifying said suspicious message as a malicious or soliciting message.

6. The method of claim 1, further comprising in response to receiving said second event enhancing said level of suspiciousness in accordance with said alerting operation.

7. A method for displaying an alerting message in a messaging system, the method comprising:
receiving an event indicating the detecting of a malicious or soliciting electronic message;
in response to said event extracting data associated with said electronic message;
generating a form; said form including said extracted data and an alerting message;
said alerting message indicating said event; said form generating a bar; to, thereby presenting said bar in a reading pan of said messaging system.

8. The method of claim 7, wherein said data comprises results of analysis of behavior of users with said messaging system.

9. The method of claim 7, wherein said results comprises reputation of a sender of said electronic message.

10. A non-transitory computer-readable storage medium storing instructions, the instructions causing the processor to perform:
receiving a first event indicating performing an alerting operation by a user; wherein said alerting operation comprises an at least one member of a group consisting of deleting said electronic message, forwarding said electronic message, flagging said electronic message and moving said electronic message to a folder; or
receiving a second event indicating the receiving of an electronic message from an non-trusted sender;
in response to said first event or said second event determining said electronic message as suspicious and determining level of suspiciousness;
enhancing said level of suspiciousness according to at least of one member of a group consisting of: determining if behavior of said user with said electronic message is within first predictable behavior; wherein said first predictable behavior derived from learning behavior of said user with said electronic message; determining if behavior of said user with said electronic message is within second predictable behavior; wherein said second predictable behavior derived from learning behavior of one or more users with same or similar electronic message; analyzing parameters associated with said electronic message, searching sender identification in a suspicious list or a trusted list wherein said suspicious list or said trusted list is generated by said learning said behavior of said user or said one or more users and analyzing awareness of said user to suspicious messages, thereby providing an enhanced level of suspiciousness; and identifying said suspicious message as a malicious or soliciting message in according with said enhanced level of suspiciousness.
